(19) United States
(12) Patent Application Publication
(10) Pub. No.: US 2006/0021004 A1
(43) Pub. Date: Jan. 26, 2006

(54) Method and system for externalized HTTP authentication

(75) Inventors: Anthony Scott Moran, Santa Cruz, CA (US); Brian Eaton, Alexandria, VA (US); Heather Maria Hinton, Austin, TX (US); Benjamin B. Harmon, Santa Cruz, CA (US)

Correspondence Address: IBM CORP (JRB);C/O LAW OFFICE OF JOSEPH R BURWELL, P O BOX 28022, AUSTIN, TX, 78755-8022, US

(73) Assignee: INTERNATIONAL BUSINESS MACHINES CORPORATION, ARMONK, NY (US)

(21) Appl. No.: 10/896,314

(22) Filed: Jul. 21, 2004

(51) Int. Cl. H04L 9/32

(52) U.S. Cl. 726/2

(57) ABSTRACT

A method is presented for providing an HTTP-based authentication mechanism. A request for a controlled resource is received from a client at a first server, which sends a request for an uncontrolled resource to a second server, which may be an HTTP-based authentication server, e.g., by redirecting a request via the client to the second server or by forwarding a request directly to the second server. The second server then obtains authentication information from the client. The second server returns the authentication credential or the authenticated identify to the first server within a response message, e.g., by storing the authentication credential within one or more HTTP headers. In response to receiving the authentication information, the first server builds a session for the client and processes the original request for the controlled resource, e.g., by sending a redirection for the controlled resource through the client.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for computer-to-computer authentication.

2. Description of Related Art

Enterprises generally desire to provide authorized users with secure access to protected/controlled resources in a user-friendly manner throughout a variety of networks, including the Internet. Many enterprises allow users to access controlled resources via HTTP-based clients, e.g., accessing web pages or web applications via web browsers. Authenticating HTTP-based clients is a common function of web-based access control systems. These control systems utilize methods for prompting a user to provide authentication data, validate this authentication data, and then perform access control decisions based on the authenticated user's credential.

The ability of access control software, devices, or systems to offload the authentication operations to an external authentication entity increases the extensibility of the access control mechanism. For example, a third-party can introduce a new authentication scheme, which can then be integrated into the external authentication entity without modifying the access control mechanism, thereby gaining efficiencies in management and maintenance.

Various techniques have been used to reduce burdens on computer system administrators with solutions that implement extensible authentication mechanisms, such as pluggable authentication modules and single-sign-on processes. However, there remains a need for an extensible authentication mechanism that adheres to HTTP functionality which can be supported along with other back-end applications within an enterprise's computing environment.

Therefore, it would be advantageous to have a method and a system for an extensible HTTP authentication mechanism that can be implemented within the infrastructure of an enterprise's computing environment.

### SUMMARY OF THE INVENTION

A method, a system, an apparatus, and a computer program product are presented for providing an HTTP-based authentication mechanism. A request for a controlled resource is received from a client at a first server, e.g., a proxy server. In response to a determination that responding to the request for the controlled resource requires an authentication credential, the first server sends a request for an uncontrolled resource to a second server, e.g., an HTTP-based authentication server, in some fashion, e.g., by redirecting a request via the client to the second server or by forwarding a request directly to the second server. The first server and the second server may be supported within the same domain. In response to receiving a request for the uncontrolled resource at the second server, the second server obtains authentication information from the client. The second server may complete the authentication operation by building an authentication credential, or the second server verifies the authentication information and determines an authenticated identity for the client. The second server returns the authentication credential or the authenticated identity to the first server within a response message, e.g., by storing the authentication credential within one or more HTTP headers. In response to receiving the authentication information, the first server builds a session for the client and processes the original request for the controlled resource, e.g., by sending a redirection for the controlled resource through the client.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 1C depicts a data flow diagram that illustrates a typical authentication process that may be used when a client attempts to access a protected resource at a server;

FIG. 1D depicts a block diagram that shows a typical data processing system for an enterprise domain that comprises multiple authentication servers;

FIG. 1E depicts a block diagram that illustrates a prior art organization of components for performing an authentication operation through pluggable authentication modules;

FIG. 1F depicts a block diagram that illustrates a typical prior art organization of systems that participate in an authentication operation that includes a single-sign-on operation;

FIG. 2 depicts a dataflow diagram that illustrates an authentication process with redirection in accordance with an embodiment of the present invention; and

FIG. 3 depicts a dataflow diagram that illustrates an authentication process without redirection in accordance with an embodiment of the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

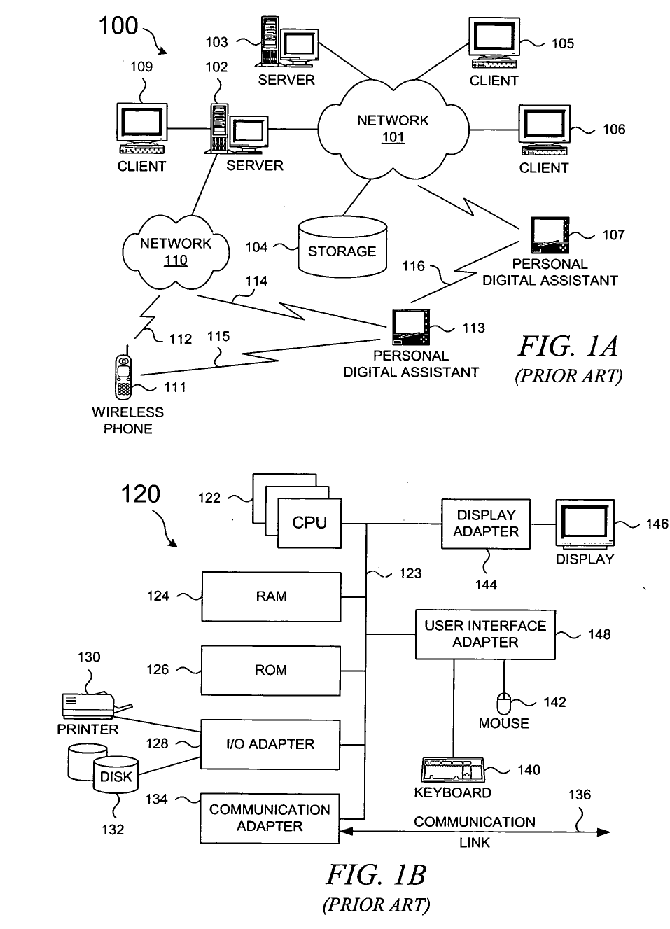

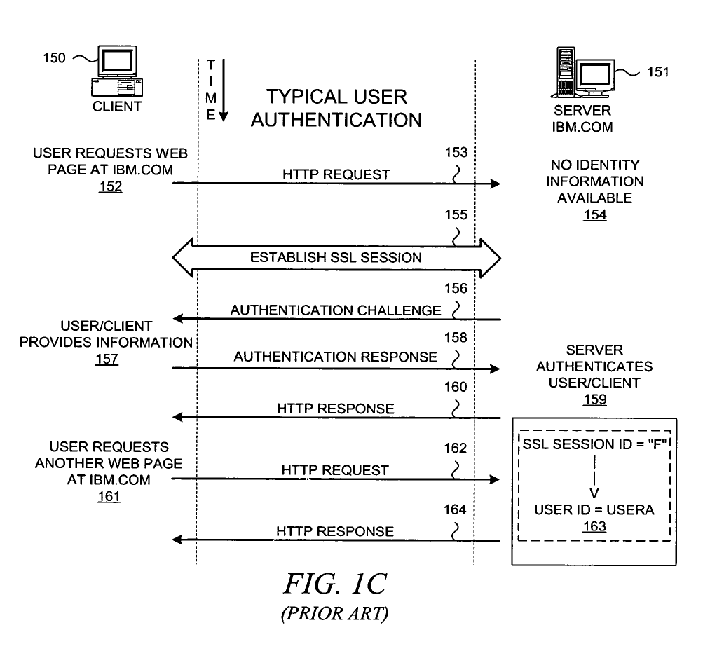

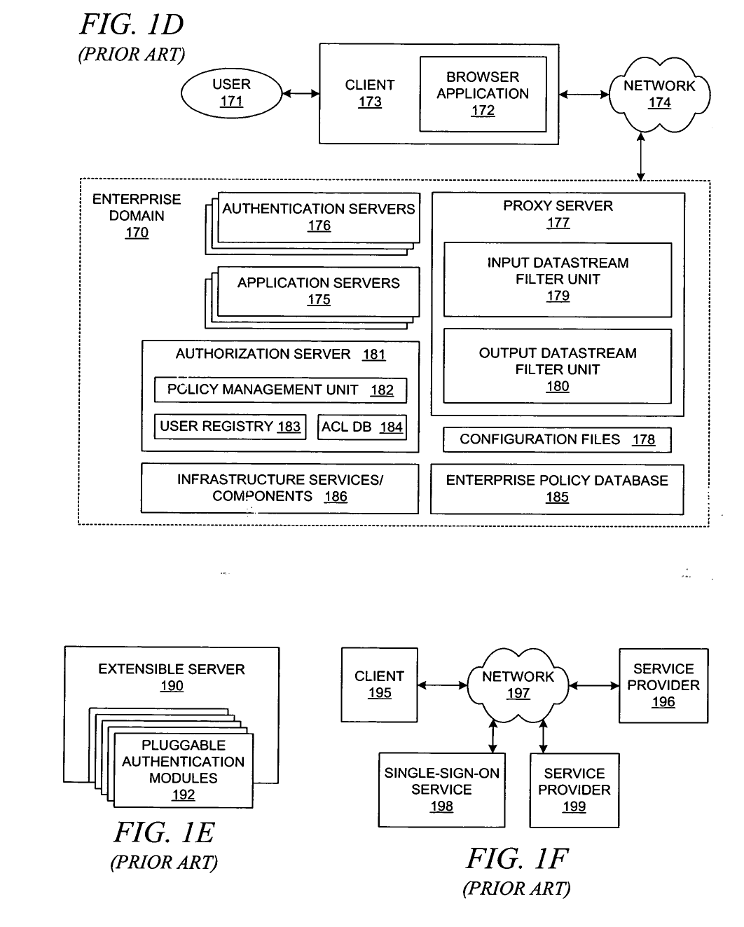

With reference now to the figures, FIG. 1A depicts a typical prior art network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as LDAP (Lightweight Directory Access Protocol), TCP/IP (Transport Control Protocol/Internet Protocol), HTTP (HyperText Transport Protocol), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116.

The present invention could be implemented on a variety of hardware platforms and software environments. FIG. 1A is intended as an example of a heterogeneous computing environment and not as an architectural limitation for the present invention.

With reference now to FIG. 1B, a diagram depicts a typical prior art computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. It should be noted that the distributed data processing system shown in FIG. 1A is contemplated as being fully able to support a variety of peer-to-peer subnets and peer-to-peer services. It should also be noted that the examples that are described herein often refer to users and clients; it should be understood that a user interacts with a client such that the client performs actions on behalf of a user, and the terms “user” and “client” can sometimes be interchanged in a well-known manner to facilitate the description of operations at a data processing system.

With reference now to FIG. 1C, a data flow diagram illustrates a typical prior art authentication process that may be used when a client attempts to access a protected resource at a server. As illustrated, the user at a client workstation 150 seeks access over a computer network to a protected resource on a server 151 through the user's web browser executing on the client workstation. A protected or controlled resource is a resource (an application, an object, a document, a page, a file, executable code, or other computational resource, communication-type resource, etc.) for which access is controlled or restricted. A protected resource is identified by a Uniform Resource Locator (URL), or more generally, a Uniform Resource Identifier (URI), that can only be accessed by an authenticated and/or authorized user. The computer network may be the Internet, an intranet, or other network, as shown in FIG. 1A or FIG. 1B, and the server may be a web application server (WAS), a server application, a servlet process, or the like.

The process is initiated when the user requests a server-side protected resource, such as a web page within the domain “ibm.com” (step 152). The terms “server-side” and “client-side” refer to actions or entities at a server or a client, respectively, within a networked environment. The web browser (or associated application or applet) generates an HTTP request (step 153) that is sent to the web server that is hosting the domain “ibm.com”. The terms “request” and “response” should be understood to comprise data formatting that is appropriate for the transfer of information that is involved in a particular operation, such as messages, communication protocol information, or other associated information.

The server determines that it does not have an active session for the client (step 154), so the server initiates and completes the establishment of an SSL (Secure Sockets Layer) session between the server and the client (step 155), which entails multiple transfers of information between the client and the server. After an SSL session is established, subsequent communication messages are transferred within the SSL session; any secret information remains secure because of the encrypted communication messages within the SSL session.

However, the server needs to determine the identity of the user before allowing the user to have access to protected resources, so the server requires the user to perform an authentication process by sending the client some type of authentication challenge (step 156). The authentication challenge may be in various formats, such as an HTML form. The user then provides the requested or required information (step 157), such as a username or other type of user identifier along with an associated password or other form of secret information.

The authentication response information is sent to the server (step 158), at which point the server authenticates the user or client (step 159), e.g., by retrieving previously submitted registration information and matching the presented authentication information with the user's stored information. Assuming the authentication is successful, an active session is established for the authenticated user or client. The server creates a session identifier for the client, and any subsequent request messages from the client within the session would be accompanied by the session identifier.

The server then retrieves the originally requested web page and sends an HTTP response message to the client (step 160), thereby fulfilling the user's original request for the protected resource. At that point, the user may request another page within “ibm.com” (step 161) by clicking a hypertext link within a browser window, and the browser sends another HTTP request message to the server (step 162). At that point, the server recognizes that the user has an active session (step 163) because the user's session identifier is returned to the server in the HTTP request message, and the server sends the requested web page back to the client in another HTTP response message (step 164). Although FIG. 1C depicts a typical prior art process, it should be noted that other alternative session state management techniques may be depicted, such as using URL rewriting or using cookies to identify users with active sessions, which may include using the same cookie that is used to provide proof of authentication.

With reference now to FIG. 1D, a block diagram depicts a typical prior art data processing system for an enterprise domain that comprises multiple authentication servers. As in a typical corporate computing environment or an Internet-based computing environment, enterprise domain 170 hosts controlled resources that user 171 can access, e.g., by using browser application 172 on client device 173 through network 174; e.g., client 173 is similar to the clients that are shown in FIG. 1A, and the servers within domain 170 are similar to the servers that are shown in FIG. 1A. Application servers 175 support access to controlled or protected resources in the form of or through web-based applications or other types of applications, including legacy applications. Authentication servers 176 support various authentication mechanisms, such as username/password, X.509 certificates, or secure tokens. Enterprise domain 170 supports multiple servers and various services and server-side infrastructure components that are able to communicate through a network, either network 174 or some other network that is not shown in the figure. Proxy server 177 performs a wide range of functions for enterprise domain 170. Proxy server 177 can be administratively configured through configuration files 178 to control the functionality of proxy server 177, e.g., caching web pages in order to mirror the content from an application server or filtering the incoming and outgoing datastreams through input datastream filter unit 179 and output datastream filter unit 180. Input datastream filter unit 179 may perform multiple checks on incoming requests while output datastream filter unit 180 may perform multiple checks on outgoing responses; each check may be performed in accordance with goals and conditions that are specified within various configuration files, property files, or other datastores. The datastream filter units may comprise multiple components that are configured as plug-ins, servlets, or in accordance with various commercially available enterprise runtime environments.

Enterprise domain 170 comprises authorization server 181. Authorization policy management unit 182 at authorization server 181 manages information within user registry 183 and access control list (ACL) database 184. Policy management unit 182 determines whether users are authorized to access certain services that are provided by application servers 175 within domain 170 by checking policies from enterprise policy database 185 against user requests for those services. Other infrastructure components or services 186 may be available for performing various functions on behalf of applications within enterprise domain 170.

The above-noted entities within enterprise domain 170 represent typical entities within many computing environments. As was shown with respect to FIG. 1C, web-based applications can utilize various means to prompt users to enter authentication information, often as a username/password combination within an HTML form. In the example that is shown in FIG. 1D, user 171 may be required to be authenticated before client 173 may have access to resources, after which a session is established for client 173 in a manner similar to that described above in FIG. 1C. In FIG. 1D, after receiving an incoming request from client 173, input datastream filter unit 179 may determine whether client 173 has already established a session; if not, an authentication service on authentication servers 176 can be invoked in order to authenticate user 171. If client 173 has already established a session, then additional checks may be performed on an incoming request prior to granting access to a controlled resource.

With reference now to FIG. 1E, a block diagram depicts a prior art organization of components for performing an authentication operation using pluggable authentication modules. FIG. 1E illustrates a so-called PAM-based authentication mechanism; extensible server 190 supports an application programming interface into which pluggable authentication modules 192 are “plugged in” to extensible server 190, i.e. through which pluggable authentication modules 192 interact with extensible server 190. Extensible server 190 is responsible for collecting information from a user during an authentication operation, and extensible server 190 passes this information to an appropriate pluggable authentication module 192, which performs the authentication determination. Assuming that the authentication operation is successful, the pluggable authentication module returns an authentication credential to extensible server 190, which then uses the authentication credential in some manner with respect to the infrastructure of its computing environment, e.g., by providing the authentication credential to an application server that provides access to controlled resources. The authentication mechanism that is illustrated with respect to FIG. 1E can be described as an externalized mechanism in that the authentication functionality is separated from the remaining functionality of the extensible server and is not embedded within the remaining functionality of the extensible server, which may be implemented as a proxy server or some other type of server.

With reference now to FIG. 1F, a block diagram depicts a typical prior art organization of systems that participate in an authentication operation that includes a single-sign-on operation. Client 195 attempts to access a controlled resource at service provider 196 via network 197, and service provider 196 redirects client 195 to complete a single-sign-on authentication operation at single-sign-on service 198. Assuming that the authentication operation is successful, the single-sign-on service redirects the client to service provider 196 such that the redirection is accompanied by the authentication credential. After receiving the authentication credential, service provider 196 provides access to the originally requested controlled resource. A user of client 195 has the additional advantage that single-sign-on service 198 can quickly provide the authentication credential in a single-sign-on fashion to service provider 199 without requiring the user to interact with single-sign-on service 198 to complete another authentication operation.

The single-sign-on functionality that is described with respect to FIG. 1F involves a front-end protocol that leverages HTTP redirection to rely on an authentication process that is completed by a trusted partner and then asserted via a trusted token or credential; this type of front-end single-sign-on functionality is described in the single-sign-on protocols that are described with respect to the WS-Federation specifications, the Liberty Alliance specifications, Security Assertion Markup Language (SAML) assertions, among others. The authentication mechanism that is illustrated with respect to FIG. 1F can be described as an externalized mechanism in that the authentication functionality is separated from the remaining functionality of the service provider and is not embedded within the remaining functionality of the service provider.

Turning now to focus on the present invention, the present invention recognizes the need to provide back-end authentication functionality that leverages HTTP functionality. In the present invention, a proxy server acts to tunnel authentication information to a back-end application, which performs an operation to collect authentication information, validate the collected information, and then build an authentication credential that is passed to the proxy server, all of which is performed in adherence to the requirements of HTTP functionality. The proxy server then builds a local session for the authenticated user. The present invention is described in more detail below with respect to the remaining figure. It should be noted that although the examples hereinbelow are described with respect to HTTP, the present invention is compatible with any messaging protocol that supports request messages, response messages, and redirection messages in a manner similar to HTTP.

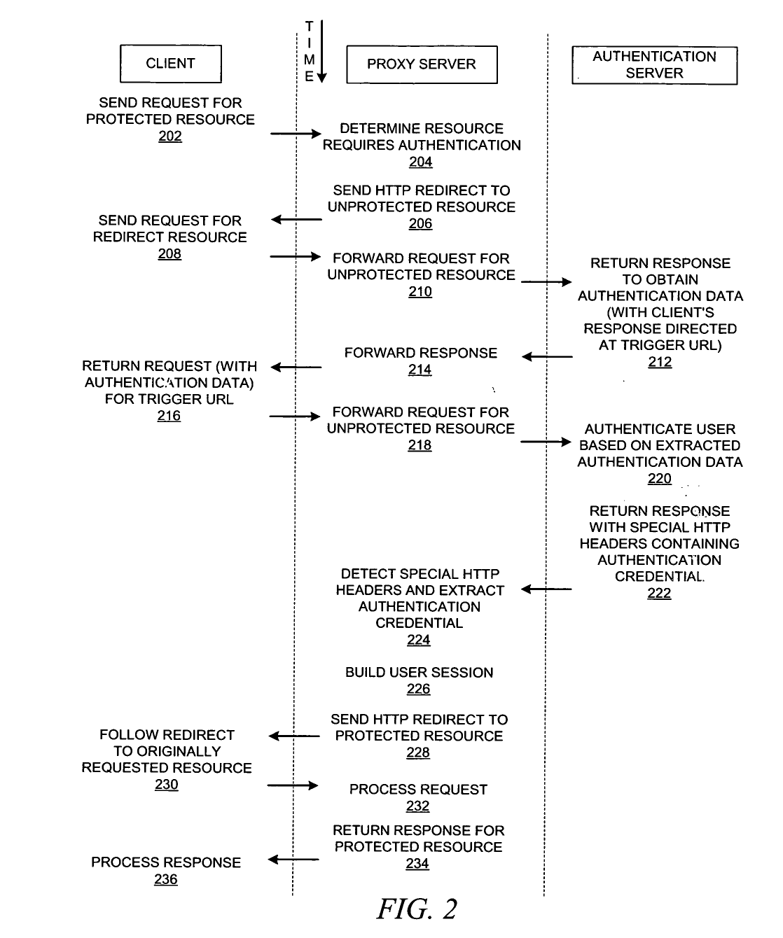

With reference now to FIG. 2, a dataflow diagram depicts an authentication process with redirection in accordance with an embodiment of the present invention. FIG. 2 is similar to FIG. 1D in that both diagrams show an authentication process between a user of a client and servers within a computing system that provides controlled access to protected resources. In contrast to FIG. 1D, however, FIG. 2 shows a proxy server that acts as an intermediate agent in order to support an externalized HTTP-based authentication operation with a back-end authentication server.

The process in FIG. 2 begins when a user of a client device, such as user 171 and client 173 that are shown in FIG. 1D, sends a request for a protected resource (step 202) to a given domain, such as domain 170 that is shown in FIG. 1D. The proxy server at the destination domain receives and scans the request using its input filter functionality, and the proxy server determines that the request is directed to a protected resource, e.g., because the input filter functionality is configured to recognize particular URI's as being associated with protected resources while other URI's are recognized as (or assumed to be) associated with unprotected resources. Given that the destination URI is a protected resource, the proxy server determines that an authentication operation or credential is required before a determination can be made as to whether the client is authorized to access the protected resource (step 204). The proxy server returns an HTTP redirect message to the client (step 206). The redirection URI may be retrieved from configuration information that is associated with the information that indicates that the originally requested URI is a protected resource; in other words, the originally requested URI may be mapped to the redirection URI.

The client subsequently receives the HTTP redirect message and sends a HTTP request for the redirection URI (step 208), which is received at the proxy server. The proxy server scans the received request and recognizes the redirection URI as being associated with an unprotected resource, thereby determining that the incoming request message does not require an authentication credential before the client is allowed to access the unprotected resource. Hence, the proxy server forwards the request to the appropriate server (step 210), which is a back-end authentication server in this case. The destination server for the unprotected resource may be indicated within configuration files or similar datastores in association the information about the unprotected resource. For example, a version of the destination URI string for the uncontrolled resource is associated in some manner with a pathname for the destination server, i.e., in accordance with some type of mapping.

The authentication server receives the forwarded request and generates a response that contains some manner for obtaining authentication information from the client/user. For example, the HTTP response message may contain a message body that is formatted as an HTML form that represents a login web page; the HTML form inherently prompts a user to enter the authentication information into the form, e.g., to provide a username and password. In some manner, the response also contains a URI to which the next request from the user should be directed, e.g., embedded within the HTML form; this URI is termed a trigger URI that initiates the actual authentication verification operation when requests from clients are directed to the trigger URI. The generated response is then sent to the proxy server (step 212). It should also be noted that the forwarded request would have an indication of the URI from the original request that caused the redirection operation; the authentication server saves the original URI for later use, e.g., by saving the original URI in association with the source IP address for the client as obtained from the received request message.

The proxy server may scan the response with its outgoing filter functionality in an attempt to detect any information that indicates that the proxy server should further process the response before it is sent along to its intended recipient. In this case, the proxy server determines that the response does not require any additional processing and forwards the response to the client (step 214).

The client receives the response from the authentication server and process the response. Assuming that the response message contains an HTML form that is intended for a web browser, then the web browser presents the HTML form as a web page to the user. The user enters the requested authentication information, e.g., a username and password, and performs some action that indicates that the provided information is ready to be returned, e.g., by clicking on an HTML control button that is embedded within the HTML form. The client then generates a request message that is sent back to the appropriate domain (step 216), which resolves in such a way as to be received at the proxy server. For example, the web browser obtains the return URI that is embedded within the HTML form and generates an HTTP GET or HTTP POST message that contains the user-provided information; in this case, the generated message contains a destination URI that is equal to the trigger URI that was previously provided by the authentication server. The authentication information may be protected through various types of security-related procedures.

The proxy server receives the request, scans the request, and recognizes the trigger URI as an unprotected resource, thereby determining that the incoming message does not require any additional processing such as obtaining an authentication credential before accessing this unprotected resource. Hence, the proxy server forwards the request to the back-end authentication server (step 218).

The authentication server receives the request and recognizes the trigger URI. The user-provided authentication data is extracted from the received request message and then is used as input to a verification process on the authentication information (step 220). In one embodiment of the present invention, the authentication information is verified such that the authentication server determines an authenticated identity for the client/user. In a different embodiment, the authentication server actually builds an authentication credential, assuming that the authentication data can be verified; the authentication credential is later associated with a session for the user that will subsequently allow the user to access protected resources within the domain for which the user is authorized. The authentication server generates an HTTP response message, and the authentication credential or the authenticated identity is placed within one or more special HTTP message headers; the authentication credential or the authenticated identity may be secured as necessary. The authentication server may also place the original URI for the originally requested protected resource within a special HTTP message header, e.g., by retrieving the original URI from a datastore after doing a lookup on the source IP address that was received in the request message. The authentication server then sends the HTTP response message to the proxy server (step 222).

The proxy server receives the HTTP response message and scans the response message. In this case, the outgoing filter functionality of the proxy server detects the special HTTP headers, which causes the proxy server to process the response further, e.g., as indicated within configuration information for the outgoing filter component or the proxy server. The proxy server extracts the authentication credential or the authenticated identity from the special HTTP headers (step 224), which is used to build a user/client session for the authenticated user/client (step 226); if only an authenticated identity is present in the response message, then the proxy server generates a formal authentication credential, possibly with the solicitation of assistance from another authentication server or some other service provider. Hence, from this point in time until the user/client is logged out or the user/client session is otherwise terminated, when the proxy server receives a request from the user/client, the proxy server will recognize that an authentication credential was previously associated with the user/client session, thereby determining that the user/client does not need to subjected to another authentication operation during the user/client session.

If the original URI was also placed within a special HTTP header, then the original URI is also extracted from the HTTP headers. The proxy server then returns an HTTP redirect message to the client (step 228), wherein the HTTP redirect message contains the original URI as the redirection URI.

The client subsequently receives the HTTP redirect message and sends an HTTP request for the redirection URI (step 230), which is received at the proxy server and processed by the proxy server (step 232), most likely with assistance by an application server that is responsible for processing a request for access to the protected resource; an optional authorization operation may be performed at this point to determine if the user/client that has just been authenticated has the necessarily privileges to access the protected resource. A response is then generated for the request to access the protected resource, and the proxy server returns the response to the client (step 234). The client then processes the response (step 236), e.g., by displaying a web page that represents the protected resource, thereby concluding the process.

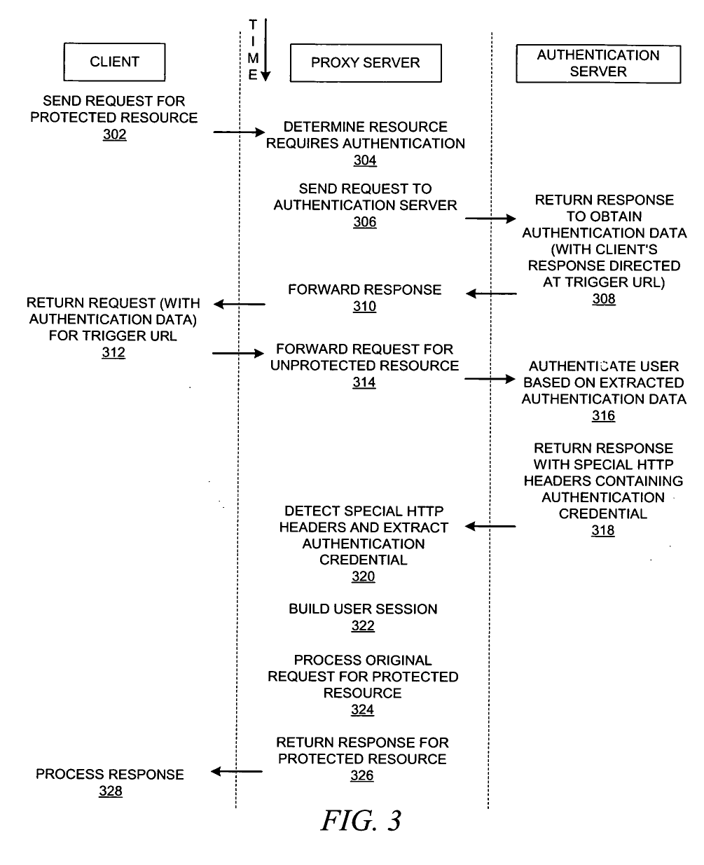

With reference now to FIG. 3, a dataflow diagram depicts an authentication process without redirection in accordance with an embodiment of the present invention. FIG. 3 is similar to FIG. 2 in that both diagrams show an authentication process between a user of a client and servers within a computing system that provides controlled access to protected resources. In contrast to FIG. 2, however, FIG. 3 shows a process that does not include redirection through the client at various steps, as can be seen by contrasting the process that is shown in FIG. 3 with the process that is shown in FIG. 2.

The process in FIG. 3 begins when a user of a client device sends a request for a protected resource (step 302) to a given domain. The proxy server determines that the request is directed to a protected resource and that an authentication operation or credential is required before a determination can be made as to whether the client is authorized to access the protected resource (step 304). The proxy server sends a new request to the appropriate server (step 306), which is a back-end authentication server in this case; the new request would include a copy of the originally requested URI.

The authentication server receives the request from the proxy server and generates a response that contains some manner for obtaining authentication information from the client/user. For example, the HTTP response message may contain a message body that is formatted as an HTML form that represents a login web page; the HTML form inherently prompts a user to enter the authentication information into the form, e.g., to provide a username and password. In some manner, the response also contains a URI to which the next request from the user should be directed, e.g., embedded within the HTML form; this URI is termed a trigger URI that initiates the actual authentication verification operation when requests from clients are directed to the trigger URI. The generated response is then sent to the proxy server (step 308). The proxy server forwards the response to the client (step 310).

The client receives the response from the authentication server and process the response. Assuming that the response message contains an HTML form that is intended for a web browser, then the web browser presents the HTML form as a web page to the user. The user enters the requested authentication information, e.g., a username and password, and performs some action that indicates that the provided information is ready to be returned, e.g., by clicking on an HTML control button that is embedded within the HTML form. The client then generates a request message that is sent back to the appropriate domain (step 312), which resolves in such a way as to be received at the proxy server. For example, the web browser obtains the return URI that is embedded within the HTML form and generates an HTTP GET or HTTP POST message that contains the user-provided information; in this case, the generated message contains a destination URI that is equal to the trigger URI that was previously provided by the authentication server. The authentication information may be protected through various types of security-related procedures.

The proxy server receives the request, scans the request, and recognizes the trigger URI as an unprotected resource, thereby determining that the incoming message does not require any additional processing such as obtaining an authentication credential before accessing this unprotected resource. Hence, the proxy server forwards the request to the back-end authentication server (step 314).

The authentication server receives the request and recognizes the trigger URI. The user-provided authentication data is extracted from the received request message and then is used as input to a verification process on the authentication information (step 316). The authentication server generates an HTTP response message, and an authentication credential or an authenticated identity is placed within one or more special HTTP message headers; the authentication credential or the authenticated identity may be secured as necessary. The authentication server may also place the previously saved original URI for the originally requested protected resource within a special HTTP message header, e.g., by retrieving the original URI from a datastore after doing a lookup on the source IP address that was received in the request message. The authentication server then sends the HTTP response message to the proxy server (step 318).

The proxy server receives the HTTP response message and scans the response message. In this case, the outgoing filter functionality of the proxy server detects the special HTTP headers, which causes the proxy server to process the response further, e.g., as indicated within configuration information for the outgoing filter component or the proxy server. The proxy server extracts the authentication credential or the authenticated identity from the special HTTP headers (step 320), which is used to build a user/client session for the authenticated user/client (step 322); if only an authenticated identity is present in the response message, then the proxy server generates a formal authentication credential, possibly with the solicitation of assistance from another authentication server or some other service provider. Hence, from this point in time until the user/client is logged out or the user/client session is otherwise terminated, when the proxy server receives a request from the user/client, the proxy server will recognize that an authentication credential was previously associated with the user/client session, thereby determining that the user/client does not need to be subjected to another authentication operation during the user/client session.

If the original URI was also placed within a special HTTP header, then the original URI is also extracted from the HTTP headers. The proxy server generates a response to the original request (step 324), most likely with assistance by an application server that is responsible for processing a request for access to the protected resource; an optional authorization operation may be performed at this point to determine if the user/client that has just been authenticated has the necessarily privileges to access the protected resource. The proxy server sends the response to the client (step 326), and the client then processes the response (step 328), e.g., by displaying a web page that represents the protected resource, thereby concluding the process.

The advantages of the present invention should be apparent to one having ordinary skill in the art with reference to the detailed description that is provided above. The present invention has advantages over a prior art pluggable-authentication module (PAM) mechanism, which provides an externalized, back-end, authentication mechanism but requires the support and maintenance involved with an application programming interface. In contrast, the present invention provides the advantages of an externalized, back-end, authentication mechanism while avoiding the disadvantages of the support and maintenance involved with an application programming interface. Moreover, it does not require that the extensible server, such as a proxy server, explicitly collect the required authentication information.

The present invention also has advantages over a prior art, HTTP-based, single-sign-on mechanism, which provides an externalized, HTTP-based, authentication mechanism but requires support through a front-end protocol. In contrast, the present invention provides the advantages of an externalized, HTTP-based, authentication mechanism while avoiding the disadvantages of the interaction involved with a trusted partner because the authentication mechanism remains within the back-end environment or infrastructure.

With the present invention, HTTP-based authentication servers may be deployed within the back-end infrastructure of a computing environment in an efficient manner. As new authentication protocols, devices, or other types of mechanisms are implemented with support for HTTP-based communication, only minimal configuration changes to the front-end infrastructure of the computing environment are required, e.g., configuration files for a proxy server. Moreover, a newly deployed authentication server does not need to be modified in any special way to be incorporated with the functionality of the present invention, other than possibly formatting the authentication credential in an expected manner, because the operations elsewhere within the infrastructure of the computing environment do not impact the operations of the authentication server.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method of performing an authentication operation within a data processing system, the method comprising:
receiving a request message for a controlled resource from a client at a first server;
invoking a second server to generate an authentication credential or an authenticated identity; and
receiving the authentication credential or the authenticated identity from the second server at the first server within a response message.

2. The method of claim 1 wherein the first server and the second server are supported within the same domain.

3. The method of claim 1 wherein the response message is an HTTP (HyperText Transport Protocol) response message.

4. The method of claim 3 further comprising:
in response to receiving the authentication credential or the authenticated identity at the first server, extracting the authentication credential or the authenticated identity from one or more HTTP headers in the HTTP response message.

5. The method of claim 1 further comprising:
in response to receiving the authentication credential or the authenticated identity at the first server, sending a first redirection message to the client from the first server, wherein the redirection message indicates a URI (Uniform Resource Identifier) for the controlled resource as the redirection URI.

6. The method of claim 1 further comprising:
in response to receiving the authentication credential or the authenticated identity at the first server, accessing the controlled resource; and
sending results from accessing the controlled resource to the client from the first server.

7. The method of claim 1 further comprising:
in response to receiving the authentication credential or the authenticated identity at the first server, building a session for the client at the first server.

8. The method of claim 7 further comprising:
receiving a subsequent request for a different controlled resource from the client at the first server; and
responding to the subsequent request without requiring the client to perform another authentication operation.

9. The method of claim 1 further comprising:
in response to a determination that responding to the request message for the controlled resource requires an authentication operation, sending a second redirection message for an uncontrolled resource at the second server to the client by the first server.

10. The method of claim 9 further comprising:
in response to receiving a request message for the uncontrolled resource from the client at the second server as redirected by the first server, sending a prompting response message from the second server to the client, wherein the prompting response message prompts a user of the client to provide authentication information from which to generate the authentication credential or the authenticated identity.

11. The method of claim 10 wherein the prompting response message comprises a web page.

12. The method of claim 10 wherein prompting response message comprises an HTML (HyperText Markup Language) form.

13. The method of claim 9 further comprising:
in response to receiving the authentication information at the second server from the client, generating the authentication credential or the authenticated identity; and
sending the authentication credential or the authenticated identity from the second server to the first server.

14. The method of claim 1 further comprising:
in response to a determination that responding to the request message for the controlled resource requires an authentication operation, sending a request message for an uncontrolled resource to the second server by the first server.

15. The method of claim 14 further comprising:
in response to receiving the request message for the uncontrolled resource from the first server at the second server, sending a prompting response message from the second server to the client, wherein the prompting response message prompts a user of the client to provide authentication information from which to generate the authentication credential or the authenticated identity.

16. An apparatus for performing an authentication operation within a data processing system, the apparatus comprising:
means for receiving a request message for a controlled resource from a client at a first server;
means for invoking a second server to generate an authentication credential or an authenticated identity; and
means for receiving the authentication credential or the authenticated identity from the second server at the first server within a response message.

17. The apparatus of claim 16 wherein the first server and the second server are supported within the same domain.

18. The apparatus of claim 16 wherein the response message is an HTTP (HyperText Transport Protocol) response message.

19. The apparatus of claim 18 further comprising:
means for extracting the authentication credential or the authenticated identity from one or more HTTP headers in the HTTP response message in response to receiving the authentication credential or the authenticated identity at the first server.

20. The apparatus of claim 16 further comprising:
means for sending a first redirection message to the client from the first server, wherein the redirection message indicates a URI (Uniform Resource Identifier) for the controlled resource as the redirection URI in response to receiving the authentication credential or the authenticated identity at the first server.

21. The apparatus of claim 16 further comprising:
means for accessing the controlled resource in response to receiving the authentication credential or the authenticated identity at the first server; and
means for sending results from accessing the controlled resource to the client from the first server.

22. The apparatus of claim 16 further comprising:
means for building a session for the client at the first server in response to receiving the authentication credential or the authenticated identity at the first server.

23. The apparatus of claim 22 further comprising:
means for receiving a subsequent request for a different controlled resource from the client at the first server; and
means for responding to the subsequent request without requiring the client to perform another authentication operation.

24. The apparatus of claim 16 further comprising:
means for sending a second redirection message for an uncontrolled resource at the second server to the client by the first server in response to a determination that responding to the request message for the controlled resource requires an authentication operation.

25. The apparatus of claim 24 further comprising:
means for sending a prompting response message from the second server to the client in response to receiving a request message for the uncontrolled resource from the client at the second server as redirected by the first server, wherein the prompting response message prompts a user of the client to provide authentication information from which to generate the authentication credential or the authenticated identity.

26. The apparatus of claim 25 wherein the prompting response message comprises a web page.

27. The apparatus of claim 25 wherein prompting response message comprises an HTML (HyperText Markup Language) form.

28. The apparatus of claim 24 further comprising:
means for generating the authentication credential or the authenticated identity in response to receiving the authentication information at the second server from the client; and
means for sending the authentication credential or the authenticated identity from the second server to the first server.

29. The apparatus of claim 16 further comprising:
means for sending a request message for an uncontrolled resource to the second server by the first server in response to a determination that responding to the request message for the controlled resource requires an authentication operation.

30. The apparatus of claim 29 further comprising:
means for sending a prompting response message from the second server to the client in response to receiving the request message for the uncontrolled resource from the first server at the second server, wherein the prompting response message prompts a user of the client to provide authentication information from which to generate the authentication credential or the authenticated identity.

31. A computer program product on a computer readable medium for use in a data processing system for performing an authentication operation, the computer program product comprising:
means for receiving a request message for a controlled resource from a client at a first server;
means for invoking a second server to generate an authentication credential or an authenticated identity; and
means for receiving the authentication credential or the authenticated identity from the second server at the first server within a response message.

32. The computer program product of claim 31 wherein the first server and the second server are supported within the same domain.

33. The computer program product of claim 31 wherein the response message is an HTTP (HyperText Transport Protocol) response message.

34. The computer program product of claim 33 further comprising:
means for extracting the authentication credential or the authenticated identity from one or more HTTP headers in the HTTP response message in response to receiving the authentication credential or the authenticated identity at the first server.

35. The computer program product of claim 31 further comprising:
means for sending a first redirection message to the client from the first server, wherein the redirection message indicates a URI (Uniform Resource Identifier) for the controlled resource as the redirection URI in response to receiving the authentication credential or the authenticated identity at the first server.

36. The computer program product of claim 31 further comprising:
means for accessing the controlled resource in response to receiving the authentication credential or the authenticated identity at the first server; and
means for sending results from accessing the controlled resource to the client from the first server.

37. The computer program product of claim 31 further comprising:
means for building a session for the client at the first server in response to receiving the authentication credential or the authenticated identity at the first server.

38. The computer program product of claim 37 further comprising:
means for receiving a subsequent request for a different controlled resource from the client at the first server; and
means for responding to the subsequent request without requiring the client to perform another authentication operation.

39. The computer program product of claim 31 further comprising:
means for sending a second redirection message for an uncontrolled resource at the second server to the client by the first server in response to a determination that responding to the request message for the controlled resource requires an authentication operation.

40. The computer program product of claim 39 further comprising:
means for sending a prompting response message from the second server to the client in response to receiving a request message for the uncontrolled resource from the client at the second server as redirected by the first server, wherein the prompting response message prompts a user of the client to provide authentication information from which to generate the authentication credential or the authenticated identity.

41. The computer program product of claim 40 wherein the prompting response message comprises a web page.

42. The computer program product of claim 40 wherein prompting response message comprises an HTML (HyperText Markup Language) form.

43. The computer program product of claim 39 further comprising:
means for generating the authentication credential or the authenticated identity in response to receiving the authentication information at the second server from the client; and
means for sending the authentication credential or the authenticated identity from the second server to the first server.

44. The computer program product of claim 31 further comprising:
means for sending a request message for an uncontrolled resource to the second server by the first server in response to a determination that responding to the request message for the controlled resource requires an authentication operation.

45. The computer program product of claim 44 further comprising:
means for sending a prompting response message from the second server to the client in response to receiving the request message for the uncontrolled resource from the first server at the second server, wherein the prompting response message prompts a user of the client to provide authentication information from which to generate the authentication credential or the authenticated identity.
